(19) United States
(12) Patent Application Publication
(10) Pub. No.: US 2026/0331809 A1
(43) Pub. Date: Oct. 22, 2026

(54) ELECTRICAL CONNECTOR

(71) Applicant: FOXCONN INTERCONNECT TECHNOLOGY LIMITED, Grand Cayman (KY)

(72) Inventors: FANG-JWU LIAO, New Taipei (TW); NAN-HUNG LIN, New Taipei (TW); SIDNEY LU, New Taipei (TW)

(21) Appl. No.: 19/649,701

(22) Filed: Apr. 16, 2026

(30) Foreign Application Priority Data
Apr. 16, 2025 (TW) 114114323

(51) Int. Cl. H01R 13/24; H01R 12/71

(52) U.S. Cl. CPC H01R 13/24; H01R 12/718

(57) ABSTRACT

An electrical connector includes: an elongated insulating body having an upper face, an opposite lower face, and terminal slots passing through the upper face and the lower face; and plural terminals each including a main portion fixed in one of the terminal slots and an upper resilient arm extending upward from the main portion. The upper resilient arm has an upper contact portion extending upward through the upper face, the insulating body has a first insulating portion and a second insulating portion along a lengthwise direction thereof, the plurality of terminals include first terminals positioned in the first insulating portion and second terminals positioned in the second insulating portion, and the upper contact portion of the first terminal is higher than the upper contact portion of the second terminal.

### BACKGROUND OF THE INVENTION

### Field of the Invention

The present disclosure relates to an electrical connector.

### Description of Related Arts

U.S. Pat. No. 11,831,094 discloses an electrical connector comprising an insulating body and terminals disposed at the insulating body. Under the connector is a circuit board electrically connected to the terminals and a back plate located below the circuit board. To prevent the circuit board from warping downwards after installation, thus avoiding poor electrical connection between the terminals and the circuit board, the back plate is arched to prevent downward deformation of the circuit board. While this method can prevent circuit board deformation to some extent and solve the problem of poor electrical contact between the terminals and the circuit board, circuit board deformation still exists, and the contact between the electrical connector and the circuit board remains poor.

Therefore, it is necessary to provide an electrical connector with an improved structure to overcome the above-mentioned defect.

### SUMMARY OF THE INVENTION

An electrical connector includes: an elongated insulating body having an upper face, an opposite lower face, and terminal slots passing through the upper face and the lower face; and plural terminals each including a main portion fixed in one of the terminal slots and an upper resilient arm extending upward from the main portion. The upper resilient arm has an upper contact portion extending upward through the upper face, the insulating body has a first insulating portion and a second insulating portion along a lengthwise direction thereof, the plurality of terminals include first terminals positioned in the first insulating portion and second terminals positioned in the second insulating portion, and the upper contact portion of the first terminal is higher than the upper contact portion of the second terminal.

An electrical connector includes: an elongated insulating body having an upper face, an opposite lower face, and terminal slots passing through the upper face and the lower face; and plural terminals each including a main portion fixed in one of the terminal slots, an upper resilient arm extending upward from the main portion, and a lower end portion extending downward from the main portion. The upper resilient arm has an upper contact portion extending upward through the upper face, the lower end portion has a lower mating portion extending downward through the lower face, the insulating body comprises a first insulating portion and a second insulating portion along a lengthwise direction thereof, the plurality of terminals include first terminals positioned in the first insulating portion and second terminals positioned in the second insulating portion, a height of the first terminal is greater than a height of the second terminal, and the upper contact portion of the first terminal protrudes upward more than the upper contact portion of the second terminal and/or the lower mating portion of the first terminal protrudes downward more than the lower mating portion of the second terminal to accommodate warping of the circuit board.

### BRIEF DESCRIPTION OF DRAWINGS

FIG. 1 shows a perspective view of an electrical connector according to a first embodiment of the present disclosure;

FIG. 2 shows another perspective view of the electrical connector of FIG. 1;

FIG. 3 shows a perspective view of the electrical connector of FIG. 1 connected to an upper circuit board and a lower circuit board;

FIG. 4 shows a front view of the electrical connector of FIG. 3;

FIG. 5 shows a front view of the electrical connector of FIG. 1, wherein the first, the second and the third terminals are separated from the insulating body;

FIG. 6 shows a perspective view of the first, the second, and the third terminals of FIG. 5;

FIG. 7 shows another perspective view of the first, the second and the third terminals of FIG. 6;

FIG. 8 shows a cross-sectional view of the electrical connector of FIG. 1 along line A-A;

FIG. 9 shows an enlarged view of a portion of the electrical connector of FIG. 8;

FIG. 10 shows a perspective view of an electrical connector according to a second embodiment of the present disclosure;

FIG. 11 shows a front view of the electrical connector of FIG. 10 connected to an upper circuit board and a lower circuit board;

FIG. 12 shows a front view of the electrical connector of FIG. 10, wherein the first, the second, and the third terminals are separated from the insulating body;

FIG. 13 shows a perspective view of the first, the second, and the third terminals of FIG. 12;

FIG. 14 shows a cross-sectional view of the electrical connector of FIG. 10 along line B-B;

FIG. 15 shows an enlarged view of a portion of the electrical connector of FIG. 14; and

FIG. 16 shows a perspective view of a terminal according to other embodiments of the present disclosure.

### DETAILED DESCRIPTION OF THE DRAWINGS

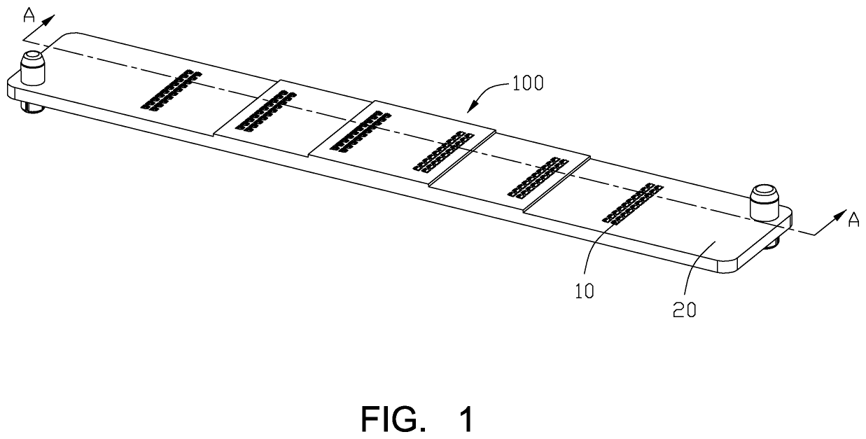

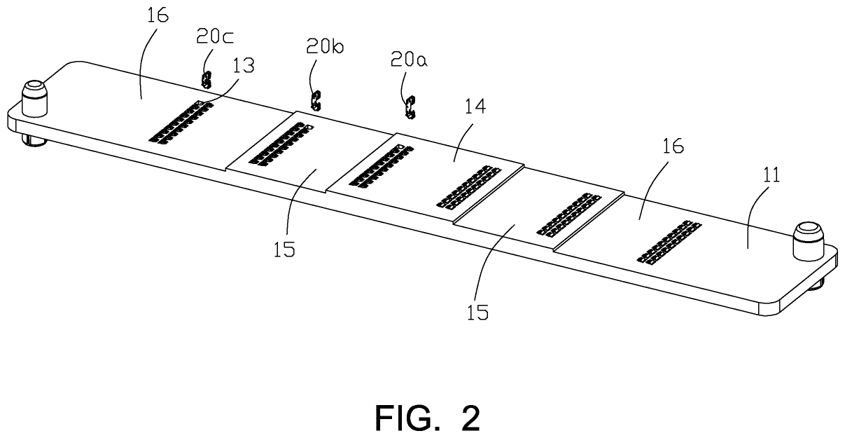

FIGS. 1-5 show an electrical connector 100 disclosed in the present disclosure. The electrical connector 100 includes an elongated insulating body 10 and a plurality of terminals 20. The insulating body 10 has an upper face 11, a lower face 12 and terminal slots 13 passing through the upper face 11 and the lower face 12. The terminals 20 are arranged respectively in the terminal slots 13. The electrical connector 100 can be used to electrically connect two circuit boards (such as PCB boards, chip modules, etc.).

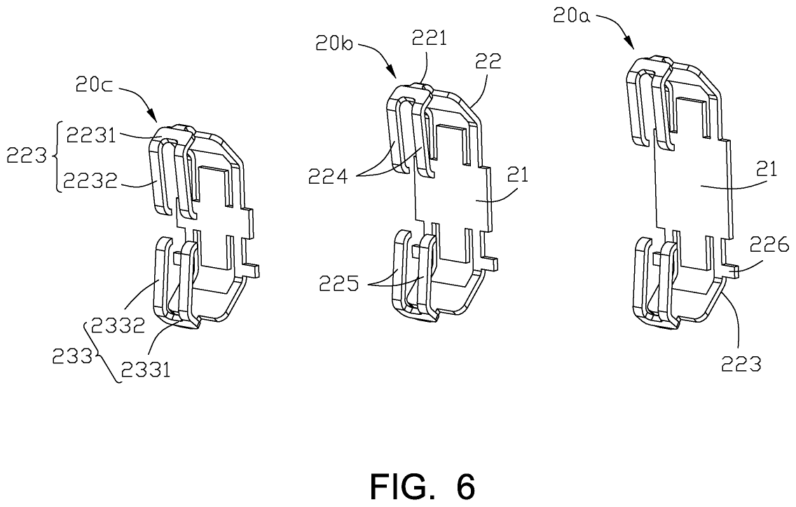

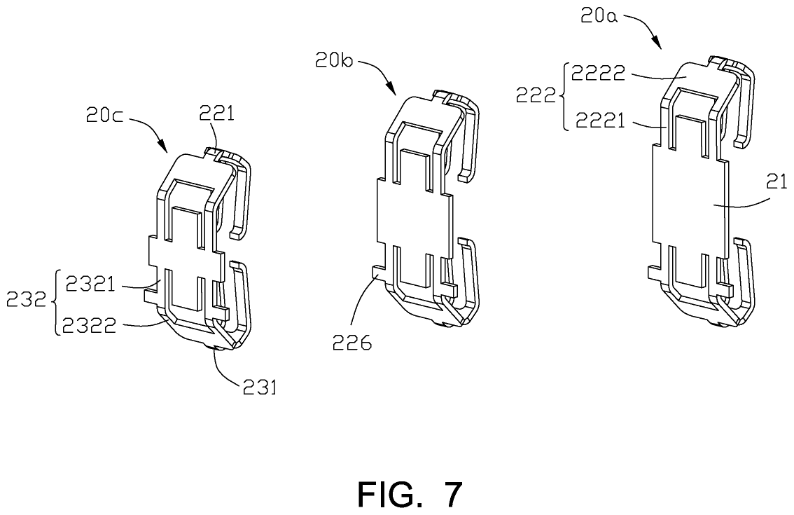

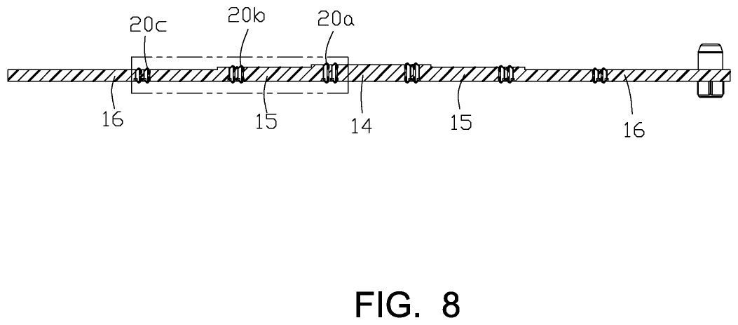

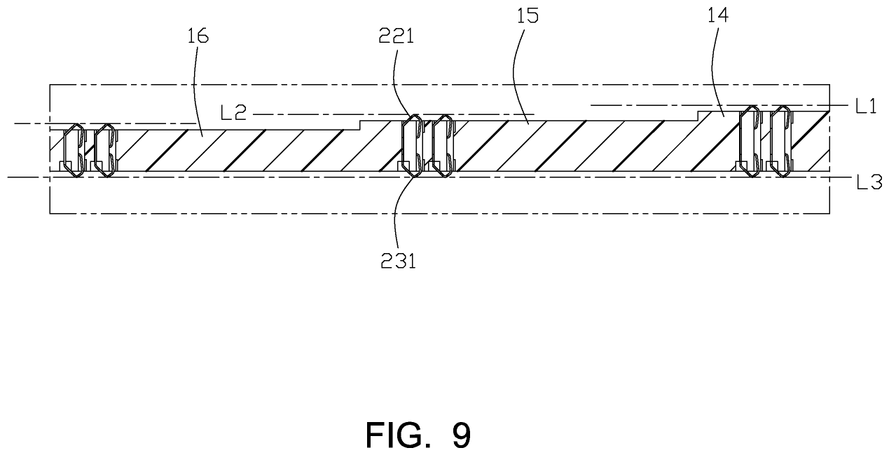

Referring to FIGS. 6-7, the terminal 20 includes a main portion 21 fixed in the terminal slot 13 and an upper resilient arm 22 extending upward from the main portion 21. The upper resilient arm 22 has an upper contact portion 221 passing upward through the upper face 11. Referring to FIGS. 8-9, the insulating body 10 has a first insulating portion 14 and a second insulating portion 15 arranged along a lengthwise direction. The terminal positioned at the first insulating portion 14 is the first terminal 20a, and the terminal positioned at the second insulating portion 15 is the second terminal 20b. The upper contact portion 221 of the first terminal 20a is higher than the upper contact portion 221 of the second terminal 20b. Namely, the upper contact portion 221 of the first terminal 20a at the first insulating portion 14 is positioned at a height L1, the upper contact portion 221 of the second terminal 20b at the second insulating portion 15 is positioned at a height L2, and L1 is greater than L2. The terminal 20 includes a lower resilient arm 23 extending downward from the main portion 21. The lower resilient arm 23 is has a lower contact portion 231 passing downwardly through the lower face 12. The lower contact portion 231 of the first terminal 20a and the lower contact portion 231 of the second terminal 20b are positioned at the same height. Specifically, the lower contact portions 231 of the terminals 20 are at the same height L3.

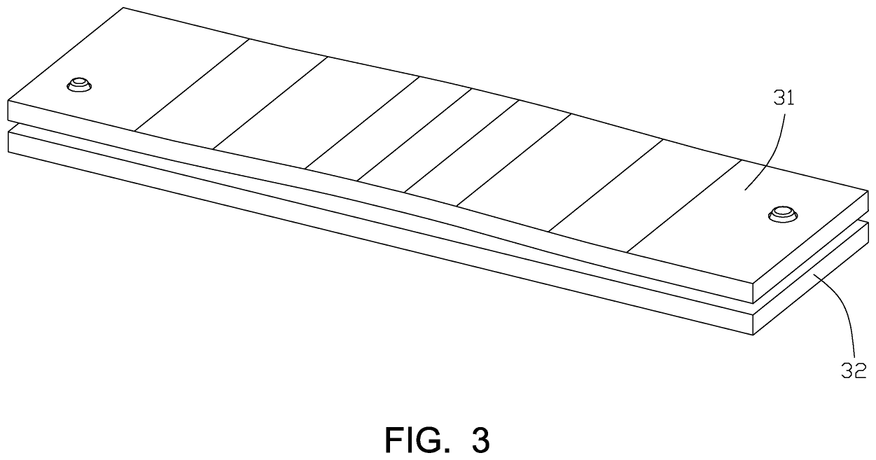

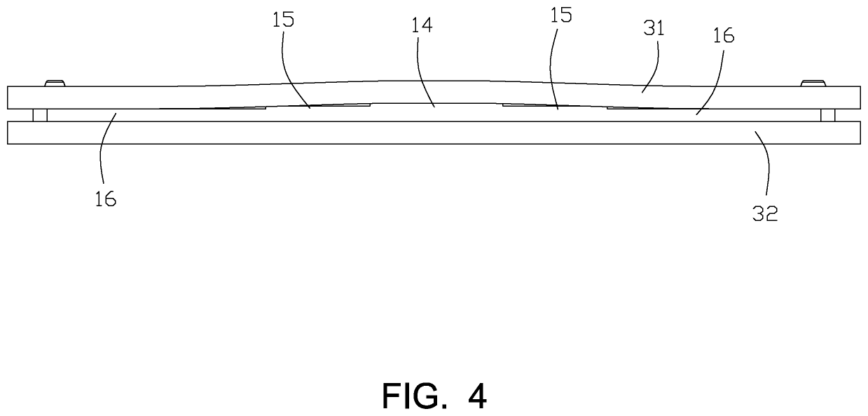

Referring to FIGS. 3-4, when the electrical connector 100 is electrically connected to an upper circuit board 31 and a lower circuit board 32, if the upper circuit board 31 warps, the different heights of the terminals 20 arranged at the first insulating portion 14 and the second insulating portion 15, namely the top of the upper contact portion 221 of the first terminal 20a at the first insulating portion 14 being higher than the top of the upper contact portion 221 of the second terminal 20b at the second insulating portion 15, allows the electrical connector 100 to better adapt to the warped shape of the upper circuit board 31, thereby maintaining better electrical connection to the upper circuit board 31.

In the present embodiment, given that the top of the upper contact portion 221 of the first terminal 20a is higher than the top of the second terminal 20b, if the upper faces of the first insulating portion 14 and the second insulating portion 15 are at the same level, the portion of the first terminal 20a protruding from the upper face 11 of the first insulating portion 14 is greater than the portion of the second terminal 20b protruding from the upper face 11 of the second insulating portion 15, causing the first terminal 20a to tilt more when the upper circuit board 31 applies a same force on the first terminal 20a and the second terminal 20b, resulting in problems such as unstable fixation of the first terminal 20a. Therefore, in the present embodiment, in order to avoid such problems, even if the upper contact portion 221 of the first terminal 20a is higher than the upper contact portion 221 of the second terminal 20b, the distance from the upper contact portion 221 of the first terminal 20a to the upper face 11 of the first insulating portion 14 is equal to the distance from the upper contact portion 221 of the second terminal 20b to the upper face 11 of the second insulating portion 15. Preferably, the present embodiment solves the problem of different protruding dimensions of the first terminal 20a and the second terminal 20b on the upper face 11 by assigning different thicknesses to the first insulating portion 14 and the second insulating portion 15.

Referring to FIGS. 8-9, specifically, when viewed along the lengthwise direction, the thickness of the first insulating portion 14 is greater than the thickness of the second insulating portion 15, such that the first insulating portion 14 protrudes upward relative to the second insulating portion 15 in a step-like manner. In this way, the distance between the upper contact portion 221 of the first terminal 20a and the upper face 11 of the first insulating portion 14 is equal to the distance between the upper contact portion 221 on the second terminal 20b and the upper face 11 of the second insulating portion 15. The upper face 11 of the first insulating portion 14 and the upper face 11 of the second insulating portion 15 are both planar. Referring to FIGS. 6-7, in the present embodiment, in order to make the upper contact portion 221 of the first terminal 20a higher than the upper contact portion 221 of the second terminal 20b, the main portion 21 of the first terminal 20a is higher than the main portion 21 of the second terminal 20b in the vertical direction. The upper resilient arm 22 of the first terminal 20a and the upper resilient arm 22 of the second terminal 20b have the same structure, and the lower resilient arm 23 of the first terminal 20a and the lower resilient arm 23 of the second terminal 20b have the same structure. The first terminal 20a and the second terminal 20b have the same structure except for the height of the main portion 21. The upper resilient arm 22 and the lower resilient arm 23 are symmetrically arranged along the vertical direction. Preferably, the upper resilient arm 22 includes in order an upper resilient portion 222, an upper contact portion 221 and an upper abutment portion 223. The lower resilient arm 23 has a lower resilient portion 232, a lower contact portion 231 and a lower abutment portion 233. The upper and lower resilient arms 22, 23 are symmetrically arranged along the vertical direction, and when the terminal 20 is pressed, the upper abutment portion 223 contacts the lower abutment portion 233.

Referring to FIGS. 6-7, in the present embodiment, the main portion 21 is plate-shaped and extends in the vertical direction. The upper resilient portion 222 extends upward from the upper edge of the main portion 21, and the lower resilient portion 232 extends downward from the lower edge of the main portion 21. The upper resilient portion 222 includes a vertical section 2221 coplanar with the main portion 21, and an inclined section 2222 inclining and extending upward from the vertical section 2221. The upper resilient portion 222 includes a slot extending from the vertical section 2221 to the inclined section 2222 to increase the resilience of the upper resilient portion 222. The upper contact portion 221 bends and extends downward from the middle of the inclined section 2222 in a thin arc shape. The upper abutment portion 223 includes a first section 2231 extending downwardly from the upper contact portion 221 and away from the main portion 21, and a second section 2232 extending from the end of the first section 2231 toward the main portion 21. Therefore, the upper abutment portion 223 forms two lower abutment arms 224 spaced apart. The lower resilient portion 232 includes a vertical section 2321 coplanar with the main portion 21 and an inclined section 2322 inclining and extending downward from the vertical section 2321. The lower resilient portion 232 includes a slot extending from the vertical section 2321 to the inclined section 2322. The lower contact portion 231 is bent upward from the middle of the inclined section 2322 in a thin arc shape. The lower abutment portion 233 includes a first section 2331 extending upward from the lower contact portion 231 and away from the main portion 21, and a second section 2332 extending upward from the first section 2331 and toward the main portion 21. The second section 2332 includes a slot extending downward from the second section 2232 to the first section 2331. Therefore, the lower abutment portion 233 forms two lower abutment arms 225 spaced apart. When the terminal 20 is pressed, the upper abutment arms 224 and the lower abutment arms 225 contact each other respectively. The terminal 20 includes a strip connecting portion 226 connected to both sides of the vertical section 2321.

In the present embodiment, the distance from the lower contact portion 231 of the first terminal 20a to the lower face 12 of the first insulating portion 14 is equal to the distance from the lower contact portion 231 of the second terminal 20b to the lower face 12 of the second insulating portion 15. Both the lower face 12 of the first insulating portion 14 and the lower face 12 of the second insulating portion 15 are planar, and are on the same horizontal plane. Preferably, the distance from the upper contact portion 221 of the first terminal 20a to the upper face 11 of the first insulating portion 14 is equal to the distance from the lower contact portion 231 of the first terminal to the lower face 12 of the first insulating portion 14.

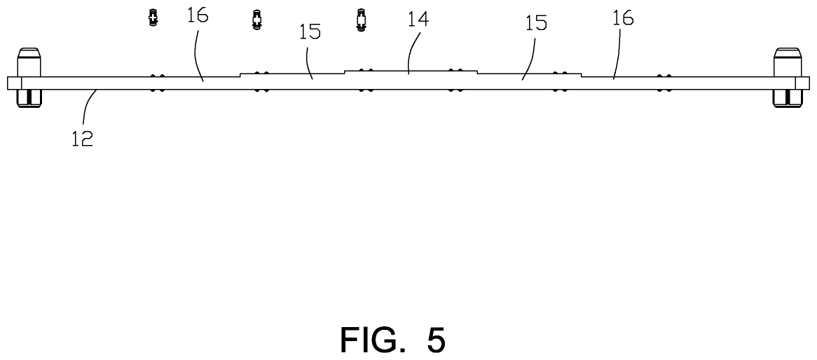

Referring to FIGS. 5 and 8-9, in the present embodiment, for better accommodating the warping of the circuit board, a quantity of the first insulating portion 14 is one and a quantity of the second insulating portion 15 is two. The two second insulating portions 15 are positioned at opposite sides of the first insulating portion 14 along a lengthwise direction. The insulating body 10 also includes two third insulating portions 16, each positioned on the side of the corresponding second insulating portion 15 away from the first insulating portion 14. The thickness of the third insulating portion 16 is less than the thickness of the second insulating portion 15. The upper face 11 of the third insulating portion 16 is lower than the upper face 11 of the second insulating portion 15. The lower face 12 of the second insulating portion 15 and the lower face 12 of the third insulating portion 16 are on the same horizontal plane. Therefore, the upper faces 11 of the first insulating portion 14, the second insulating portion 15, and the third insulating portion 16 are stepped downwards sequentially, and the lower faces 12 of the first, second, and third insulating portions 14, 15, and 16 are on the same horizontal plane.

Referring to FIGS. 6-9, the terminal 20 positioned in the third insulating portion 16 is the third terminal 20c. The upper resilient arm 22 of the third terminal 20c has the same structure as the upper resilient arm 22 of the second terminal 20b. The lower resilient arm 23 of the third terminal 20c has the same structure as the lower resilient arm 23 of the second terminal 20b. The height of the main portion 21 of the third terminal 20c is smaller than the height of the main portion 21 of the second terminal 20b. The distance from the upper contact portion 221 of the second terminal 20b to the upper face 11 of the second insulating portion 15 is equal to the distance from the upper contact portion 221 of the third terminal 20c to the upper face 11 of the third insulating portion 16. The distance from the lower contact portion 231 of the second terminal 20b to the lower face 12 of the second insulating portion 15 is equal to the distance from the lower contact portion 231 of the third terminal 20c to the lower face of the third insulating portion 16. Therefore, the distance from the upper contact portion 221 of the first terminal 20a to the upper face 11 of the first insulating portion 14 is equal to the distance from the upper contact portion 221 of the second terminal 20b to the upper face of the second insulating portion 15, and also equal to the distance from the upper contact portion 221 of the third terminal 20c to the upper face 11 of the third insulating portion 16. In other words, the distances from the upper contact portions 221 of the first, second, and third terminals 20a, 20b, and 20c to their corresponding upper faces 11 are the same. Likewise, the distance from the lower contact portion 231 of the first terminal 20a to the lower face 12 of the first insulating portion 14 is equal to the distance from the lower contact portion 231 of the second terminal 20b to the lower face of the second insulating portion 15, and also equal to the distance from the lower contact portion 231 of the third terminal 20c to the lower face 11 of the third insulating portion 16. In other words, the distances from the lower contact portions 231 of the first, second, and third terminals 20a, 20b, and 20c to their corresponding lower faces 12 are the same. In the present embodiment, the three types of terminals 20a, 20b, and 20c are identical except for the height of the main portion 21, and the upper resilient arm 22 and the lower resilient arm 23 are symmetrically arranged in the vertical direction.

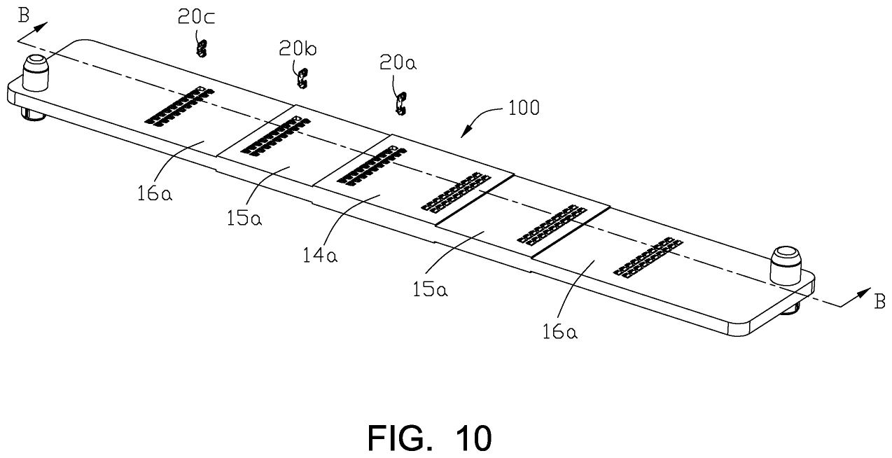

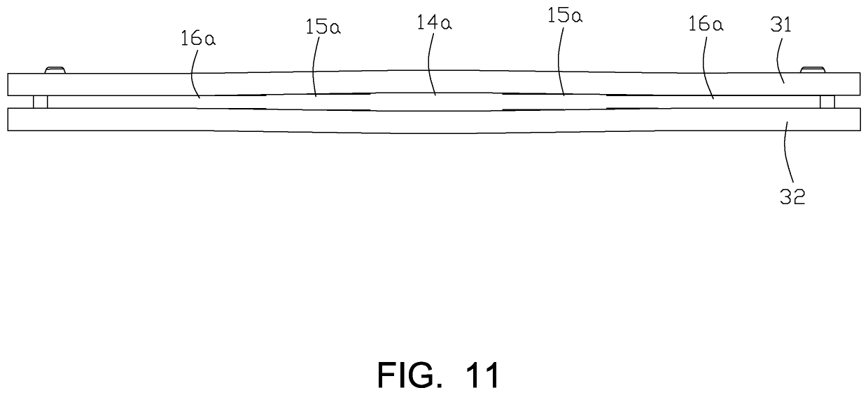

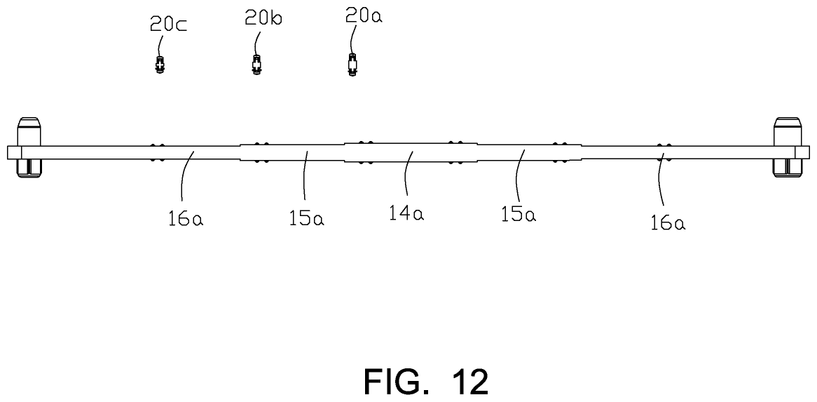

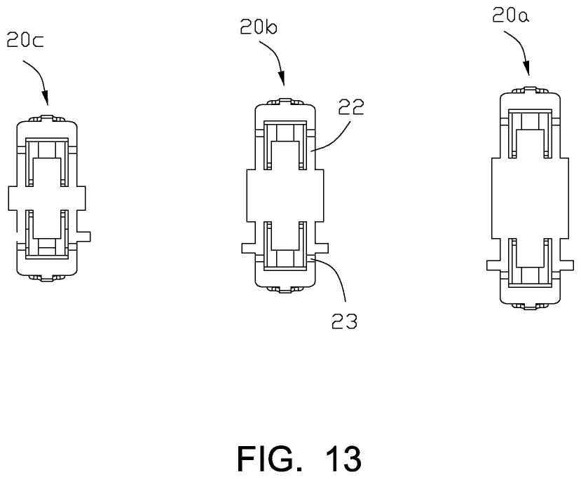

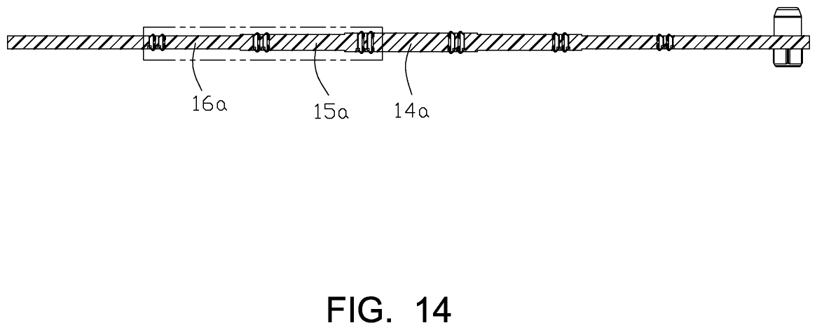

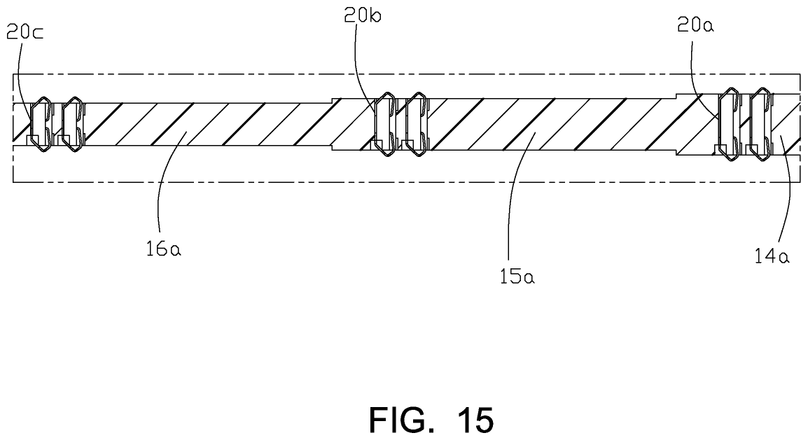

FIGS. 10-15 show the electrical connector 100 of the second embodiment of the present disclosure. The structures of the first terminal 20a, the second terminal 20b, and the third terminal 20c are basically the same as those of the first embodiment. Except for the difference in height of the main portion 21, the structures of the first, second, and third terminals 20a, 20b, and 20c are the same. Furthermore, the upper resilient arm 22 and the lower resilient arm 23 of the terminal 20 are symmetrically arranged in the vertical direction. In addition, the distance from the first terminal 20a to the upper face of the first insulating portion 14a is equal to the distance from the second terminal 20b to the upper face of the second insulating portion 15a, and also equal to the distance from the third terminal 20c to the upper face of the third insulating portion 16a. Likewise, the distances from the lower abutment portions 231 of the first, second, and third terminals 20a, 20b, and 20c to the corresponding lower faces 12 are also the same. Namely, the distance from the first terminal 20a to the lower face 12 of the first insulating portion 14a is equal to the distance from the second terminal 20b to the lower face 12 of the second insulating portion 15a, and also equal to the distance from the third terminal 20c to the lower face 12 of the third insulating portion 16a. The upper faces 11 of the first insulating portion 14a, the second insulating portion 15a, and the third insulating portion 16a are stepped downwards. Unlike the first embodiment, to better accommodate the warping of both the upper and lower circuit boards 31 and 32, in the present embodiment, the lower faces 12 of the first insulating portion 14a, the second insulating portion 15a, and the third insulating portion 16a are stepped upwards. Namely, the lower face 12 of the first insulating portion 14a is lower than the lower face 12 of the second insulating portion 15a, and the lower surface 12 of the second insulating portion 15a is lower than the lower face 12 of the third insulating portion 16a.

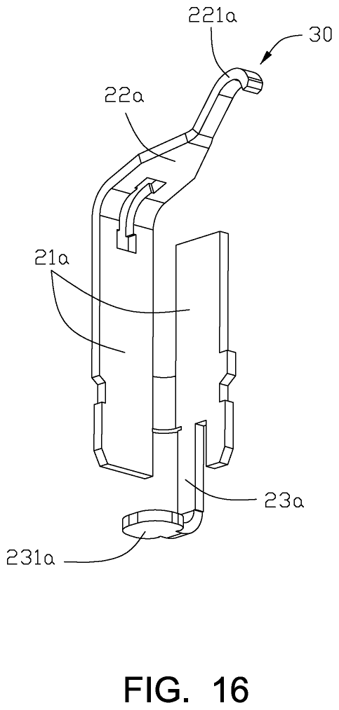

Referring to FIG. 16, in other embodiments of the present disclosure, the terminal of the first embodiment can also be configured as a terminal 30 of other types. Preferably, the terminal 30 includes a main portion 21a fixed in the terminal slot 13, an upper resilient arm 22a extending upward from the main portion 21a, and a lower end portion extending downward from the main portion 21a. The lower end portion has a lower mating portion extending downward from the lower face 11. The upper resilient arm 22a has an upper contact portion 221a extending upward through the upper face of the insulating body 10. In the present embodiment, the lower end portion of the terminal 30 is no longer a lower resilient arm extending downward from the main portion 21a, but a solder leg 23a extending downward from the main portion 21a. The mating portion is a solder portion 231a extending downward from the main portion 21a and passing through the lower face 11, such as a solder pad. The main portion 21a has two vertically extending plates arranged at approximately 90 degrees relative to each other. Other structures (such as the insulating body) are the same as those in the first embodiment.

In other embodiments of the present disclosure, the terminal 20 in the second embodiment may also be configured as the terminal shown in FIG. 16, while other structures (such as the insulating body 10) are the same as those in the second embodiment.

In the first and second embodiments of the present disclosure, to make the upper contact portion 221 of the first terminal 20a higher than the upper contact portion of the second terminal 20b, the present disclosure achieves this by increasing the height of the main portion 21 of the first terminal 20a. However, since the structures of the upper resilient arms 22 of the first terminal 20a and the second terminal 20b are the same, it is understood that in other embodiments, this can also be achieved by increasing the height of the upper resilient arm 22 of the first terminal 20a. For example, the heights of the main portions 21 of the first terminal 20a and the second terminal 20b are the same, and the height of the upper resilient arm 22 of the first terminal 20a is greater than the height of the upper resilient arm 22 of the second terminal 20b. Similarly, to make the lower contact portion 231 of the first terminal 20a lower than the lower contact portion of the second terminal 20b, this can be achieved by making the height of the lower resilient arm 22 of the first terminal 20a greater than the height of the lower resilient arm 22 of the second terminal 20b. Therefore, regardless of the method used, as long as the height of the first terminal 20a in the vertical direction is greater than that of the second terminal 20b, and the upper contact portion 221 of the first terminal 20a protrudes upward relative to the upper contact portion 221 of the second terminal 20b, and/or the lower end of the first terminal 20a having a lower mating portion (such as a lower resilient arm or a solder pad) protrudes downward relative to the lower mating portion of the second terminal, it is sufficient to adapt to a warping circuit board.

It should be noted that for this type of electrical connector 100, the quantity of terminals 20 is relatively large, possibly thousands. The present disclosure only schematically shows a portion of the terminals 20 and the terminal slots 13 that accommodate these terminals 20. The present disclosure only shows four rows of terminals on the first insulating portions 14, 14a, two rows of terminals on each of the second insulating portions 15, 15a, and two rows of terminals on each of the third insulating portions 16, 16a. In practice, rows of terminals 20 arranged in a matrix are provided on the first, second, and third insulating portions 14, 15, 16.

The above embodiments are preferred embodiments of the present disclosure, but not all embodiments. Any equivalent changes to the technical solutions of the present disclosure made by those skilled in the art by reading the present disclosure are covered by the claims of the present disclosure.

1. An electrical connector comprising:
an elongated insulating body having an upper face, an opposite lower face, and terminal slots passing through the upper face and the lower face; and
a plurality of terminals each including a main portion fixed in one of the terminal slots and an upper resilient arm extending upward from the main portion;
wherein the upper resilient arm has an upper contact portion extending upward through the upper face, the insulating body has a first insulating portion and a second insulating portion along a lengthwise direction thereof, the plurality of terminals include first terminals positioned in the first insulating portion and second terminals positioned in the second insulating portion, and the upper contact portion of the first terminal is higher than the upper contact portion of the second terminal.

2. The electrical connector according to claim 1, wherein each of the terminals has a lower resilient arm extending downward from the main portion, the lower resilient arm has a lower contact portion extending downward through the lower face, and the lower contact portion of the first terminal is lower than the lower contact portion of the second terminal.

3. The electrical connector according to claim 2, wherein he thickness of the first insulating portion is greater than the thickness of the second insulating portion, the upper and lower faces of the first and second insulating portions are planar, the upper face of the first insulating portion protrude upward in a stepped manner compared to the upper face of the second insulating portion and the lower face of the first insulating portion protrude downward in a stepped manner relative to the lower face of the second insulating portion.

4. The electrical connector according to claim 2, wherein the height of the main portion of the first terminal is greater than the height of the main portion of the second terminal, and the first insulating portion protrudes upward and downward in a stepped manner relative to the second insulating portion.

5. The electrical connector according to claim 1, wherein each of the terminals has a lower elastic arm extending downward from the main portion, the lower resilient arm has a lower contact portion extending downward through the lower face, and the lower contact portion of the first terminal and the lower contact portion of the second terminal are at the same height.

6. The electrical connector according to claim 5, wherein the thickness of the first insulating portion is greater than the thickness of the second insulating portion, the height of the main portion of the first terminal is greater than the height of the main portion of the second terminal, the distance from the upper contact portion of the first terminal to the upper face of the first insulating portion is equal to the distance from the upper contact portion of the second terminal to the upper face of the second insulating portion, and the distance from the lower contact portion of the first terminal to the lower face of the first insulating portion is equal to the distance from the lower contact portion of the second terminal to the lower face of the second insulating portion.

7. The electrical connector according to claim 5, wherein the thickness of the first insulating portion is greater than the thickness of the second insulating portion, the upper and lower faces of the first and second insulating portions are planar, the upper face of the first insulating portion protrudes upward in a stepped manner compared to the upper face of the second insulating portion, and the lower face of the first insulating portion is flush with the lower face of the second insulating portion.

8. The electrical connector according to claim 5, wherein the height of the main portion of the first terminal is greater than the height of the main portion of the second terminal, the first insulating portion protrudes upward in a stepped manner relative to the second insulating portion, and the lower faces of the first insulating portion and the second insulating portion are flush.

9. The electrical connector according to claim 1, wherein the height of the main portion of the first terminal is greater than the height of the main portion of the second terminal, the thickness of the first insulating portion is greater than the thickness of the second insulating portion, the upper resilient arm of the first terminal and the upper resilient arm of the second terminal are the same, and the distance from the upper contact portion of the first terminal to the upper face of the first insulating portion is equal to the distance from the upper contact portion of the second terminal to the upper face of the second insulating portion.

10. The electrical connector according to claim 9, wherein the insulating body comprises two second insulating portions, and the two second insulating portions are positioned at opposite sides of the first insulating portion along the lengthwise direction.

11. The electrical connector according to claim 10, wherein the insulating body comprises two third insulating portions, each of the third insulating portions is positioned on the side of the corresponding second insulating portion away from the first insulating portion, a terminal positioned in the third insulating portion is a third terminal, and the upper contact portion of the third terminal is lower than the upper contact portion of the second terminal.

12. The electrical connector according to claim 11, wherein the height of the main portion of the second terminal is greater than the height of the main portion of the third terminal, the thickness of the second insulating portion is greater than the thickness of the third insulating portion, and upper the resilient arm of the third terminal is the same as the upper resilient arm of the second terminal, the distance from the upper contact portion of the second terminal to the upper face of the second insulating portion is equal to the distance from the upper contact portion of the third terminal to the upper face of the third insulating portion, and the upper faces of the first insulating portion, the second insulating portion, and the third insulating portion are stepped downwards sequentially.

13. The electrical connector according to claim 12, wherein the upper resilient arm sequentially comprises an upper resilient portion, an upper contact portion, and an upper abutment portion; the lower resilient arm has a lower resilient portion, a lower contact portion, and a lower abutment portion; the upper and lower resilient arms are symmetrically arranged in the vertical direction, and when the terminal is pressed, the upper abutment portion contacts the lower abutment portion.

14. The electrical connector according to claim 1, wherein the terminal has a solder leg extending downward from the main portion, the solder leg has a solder portion extending downward through the lower face, the solder portion of the first terminal and the solder portion of the second terminal are at the same height, or the solder portion of the first terminal is lower than the solder portion of the second terminal.

15. An electrical connector for connecting to a circuit board, comprising:
an elongated insulating body having an upper face, an opposite lower face, and a plurality of terminal slots passing through the upper face and the lower face; and
a plurality of terminals each having a main portion fixed in one of the terminal slots, an upper resilient arm extending upward from the main portion, and a lower end portion extending downward from the main portion; wherein
the upper resilient arm has an upper contact portion extending upward through the upper face, the lower end portion has a lower mating portion extending downward through the lower face, the insulating body comprises a first insulating portion and a second insulating portion along a lengthwise direction thereof, the plurality of terminals include first terminals positioned in the first insulating portion and second terminals positioned in the second insulating portion, a height of the first terminal is greater than a height of the second terminal, and the upper contact portion of the first terminal protrudes upward more than the upper contact portion of the second terminal and/or the lower mating portion of the first terminal protrudes downward more than the lower mating portion of the second terminal to accommodate warping of the circuit board.

16. The electrical connector according to claim 15, wherein the thickness of the first insulating portion is greater than the thickness of the second insulating portion, a distance from the upper contact portion of the first terminal to the upper face of the first insulating portion is equal to a distance from the upper contact portion of the second terminal to the upper face of the second insulating portion, and a distance from the lower mating portion of the first terminal to the lower face of the first insulating portion is equal to a distance from the lower mating portion of the second terminal to the lower face of the second insulating portion.

17. The electrical connector according to claim 15, wherein the lower end portion is a lower resilient arm, and the lower mating portion is a lower contact portion.

18. The electrical connector according to claim 15, wherein the lower end portion is a solder leg, and the lower mating portion is a solder portion.
